(19) United States
(12) Patent Application Publication
(10) Pub. No.: US 2026/0119639 A1
(43) Pub. Date: Apr. 30, 2026

(54) AUTHENTICATION METHOD

(71) Applicant: STMicroelectronics International N.V., Geneva (CH)

(72) Inventors: Thierry SIMON, Wavre (BE); Michael PEETERS, Tourinnes-la-Grosse (BE)

(73) Assignee: STMicroelectronics International N.V., Geneva (CH)

(21) Appl. No.: 19/370,195

(22) Filed: Oct. 27, 2025

(30) Foreign Application Priority Data
Oct. 29, 2024 (FR) FR2411830

(51) Int. Cl. G06F 21/44; G06F 21/33

(52) U.S. Cl. CPC G06F 21/44; G06F 21/33

(57) ABSTRACT

A method of authenticating a first device to a second device, where the first device stores a first list of data groups, includes the following steps: a) sending, by the second device to the first device, a second list of information relative to data; b) sending, by the first device to the second device, a third list of images, by a first function, of data of said first list of data groups, having as information that of said second list of information relative to data; and c) verifying, by the second device, whether the images of the data of said third list of images comply with the data of a fourth list of data groups corresponding to the image of the first list of data groups by a second function having its information comprised in the second list of information relative to data.

### PRIORITY CLAIM

This application claims the priority benefit of French Application for Patent No. FR2411830 filed on Oct. 29, 2024, the content of which is hereby incorporated by reference in its entirety to the maximum extent allowable by law.

### TECHNICAL FIELD

The present disclosure generally concerns electronic circuits and devices and, more particularly, the security of electronic circuits and devices. The present disclosure more precisely relates to the implementation of an authentication method enabling, for example, a plurality of electronic devices to start a reliable communication.

### BACKGROUND

A communication between two electronic devices, or circuits, is often preceded by an authentication phase. During this phase, an authentication method, implemented by the two devices, enables to verify whether the two devices are authorized to communicate with each other.

Authentication methods are often used in communications between a device of terminal type and an electronic equipment or device of peripheral type, for example a consumable or an accessory. The authentication method enables, in this case, to validate the access by the peripheral device to data and/or functionalities of the terminal device. The authentication method is a first means of protection against malicious devices trying to access data and/or functionalities of other devices.

It would be desirable to be able to improve, at least partly, known authentication methods.

There exists a need for more secure authentication methods, allowing a more robust authentication of an electronic circuit or device to another electronic circuit or device, and in particular a more robust authentication against fault injection attacks.

In particular, there exists a need to prevent a clone of an electronic device from authenticating itself in its place.

There exists a need for electronic circuits and devices implementing more secure authentication methods.

There is a need to overcomes all or part of the disadvantages of known authentication methods.

### SUMMARY

An embodiment provides an authentication method of verifier/prover type in which a prover device stores far more data than data which are effectively used and potentially disclosed during the implementation of an authentication method.

According to a first aspect, an embodiment provides a method of authenticating a first device to a second device, the first device storing a first list of data groups, comprising the following steps: a) sending, by the second device to the first device, a second list of information relative to data; b) sending, by the first device to the second device, a third list of images, by a first function, of data of said first list of data groups having as information those of said second list of information relative to data; and c) verifying, by the second device, whether the images of the data of said third list of images comply with the data of a fourth list of data groups corresponding to the image of the first list of data groups by a second function having its information comprised in the second list of information relative to data.

Another embodiment provides an electronic device configured to operate as a first device in a method of authenticating the first device to a second device, the first device storing a first list of data groups, and said method comprising the steps of: a) sending, by the second device to the first device, a second list of information relative to data; b) sending, by the first device to the second device, a third list of images, by a first function, of data of said first list of data groups having as information that of said second list of information relative to data; and c) verifying, by the second device, whether the images of the data of said third list of images comply with the data of a fourth list of data groups corresponding to the image of the first list of data groups by a second function having its information comprised in the second list of information relative to data.

Another embodiment provides an electronic device configured to operate as a second device in a method of authenticating a first device to the second device, the first device storing a first list of data groups, and said method comprising the following steps: a) sending, by the second device to the first device, a second list of information relative to data; b) sending, by the first device to the second device, a third list of images, by a first function, of data of said first list of data groups having as information that of said second list of information relative to data; and c) verifying, by the second device, whether the images of the data of said third list of images comply with the data of a fourth list of data groups corresponding to the image of the first list of data groups by a second function having its information comprised in the second list of information relative to data.

According to an embodiment, the method further comprises a step d), preceding step a), of sending, by the first device to the second device, said fourth list of data groups.

According to an embodiment, the method further comprises a step e), executed between steps b) and c), of deleting, by the first device, from said first list of data groups the entire data groups of data having their information forming part of said third list of images.

According to an embodiment, said second list of information relative to data is a list of data indexes.

According to an embodiment, said second list of information relative to data is a list of data values.

According to an embodiment, said method comprises, between step d) and step a), a step f) in which said first device sends, to the second device, a fifth list of information relative to data groups of said fourth list of data groups which have already been used to implement an authentication method, and at step a), the second list of information relative to data comprises no information already comprised in said fifth list of information relative to data groups.

According to an embodiment, the fifth list of information relative to data groups comprises pairs comprising a data index and the value of said data associated with said data index.

According to an embodiment, said method further comprises, after step f), a step G), implemented by the second device, of verification of said fifth list of information relative to data groups.

According to an embodiment, at step d) the first device further sends a certificate, and said method comprises, after step d), a step h), implemented by said second device, of verification of said certificate.

According to an embodiment, said first device comprises a counter configured to count the number of times that the first device implements said authentication method.

According to an embodiment, when said counter exceeds a maximum value, said first device stops the implementation of the authentication method and is not authenticated to the second device.

According to an embodiment, said second device is configured to verify the value of said counter.

According to an embodiment, if the verification of step c) is a success, then the first device is authenticated to the second device, and if the verification of step c) is not a success, then the first device is not authenticated to the second device.

Another embodiment provides an authentication system comprising the first device and the second device as previously-described above.

Another embodiment provides a computer program product comprising program code instructions for the execution of the steps of the previously described method as the first device or as the second device when said program is executed on a computer.

According to a second aspect, an embodiment provides a method of authenticating a first device to a second device, the first device storing a first list of data groups, comprising the following steps: a) sending, by the first device to the second device, a second list of data groups corresponding to the image of the first list of data groups by a first function; b) sending, by the first device to the second device, a fourth list of images, by a second function, of data of said first list of data groups having as information that of a third list; and c) verifying, by the second device, whether the images of the data of said fourth list comply with the data of said second list of data groups having their information comprised in the third list.

An embodiment provides a device configured to operate as the first device according to the above authentication method.

An embodiment provides a device configured to operate as the second device according to the above authentication method.

An embodiment provides a system comprising the first and second devices configured to implement the above authentication method.

An embodiment provides a computer program product comprising program code instructions for the execution of the steps of the previously-described method as the first device and/or as the second device when said program is executed on a computer.

The alternatives described in relation with the first aspect are applicable to the embodiments of the second aspect wherever possible.

According to a third aspect, an embodiment provides a method of authenticating a first device to a second device, the first device storing a first list of data groups, comprising the following steps: a) sending, by the first device to the second device, a second list of data groups corresponding to the image of the first list by a first function; b) sending, by the second device to the first device, a third list of information relative to data; c) sending, by the first device to the second device, a fourth list of images, by a second function, of data of said first list of data groups having as information that of said third list of information relative to data; and d) verifying, by the second device, whether the images of the data of said fourth list of images comply with the data of said second list of data groups having their information comprised in the third list of information relative to data.

An embodiment provides a device configured to operate as the first device according to the above authentication method.

An embodiment provides a device configured to operate as the second device according to the above authentication method.

An embodiment provides a system comprising the first and second devices configured to implement the above authentication method.

An embodiment provides a computer program product comprising program code instructions for the execution of the steps of the previously-described method as the first device and/or as the second device when said program is executed on a computer.

The alternatives described in relation to the first aspect are applicable to the embodiments of the third aspect wherever possible.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an example of an electronic device configured to implement the implementation modes of an authentication method;

FIG. 2 shows a block diagram illustrating an implementation mode of a method of authenticating a first device to a second device;

FIG. 3 shows a block diagram illustrating the implementation of a step in the implementation mode of FIG. 1; and

FIG. 4 shows a block diagram illustrating another implementation mode of a method of authenticating a first device to a second device.

### DETAILED DESCRIPTION

The same elements have been designated by the same references in the various figures. In particular, structural and/or functional elements common to the various embodiments may have the same references and may have identical structural, dimensional and material properties.

For the sake of clarity, only those steps and elements that are useful for understanding the described embodiments have been shown and are described in detail.

Unless otherwise specified, when reference is made to two elements being connected to each other, this means directly connected without any intermediate elements other than conductors, and when reference is made to two elements being coupled to each other, this means that these two elements may be connected or may be connected via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the figures.

Unless otherwise specified, the expressions “about”, “approximately”, “substantially”, and “of the order of” mean to within 10%, preferably to within 5%.

The embodiments described hereafter concern the implementation of an authentication method enabling to authenticate a first electronic device to a second electronic device, for example, with a view to a future communication between these first and second devices. These embodiments are, more particularly, authentication methods of verifier/prover type, also known as verifier/candidate type, in which a verifier device, here the second device, selects one or a plurality of pieces of data which are to be revealed by the prover device, here the first device, and asks it to reveal them. The prover device then sends either the requested piece or pieces of data, or the result of the application of a transformation to these data back to the verifier device so that it verifies whether the prover device has the correct data in its possession. If the result of the verification is correct, then the prover device is authenticated to the verifier device. There is called authentication system an electronic system comprising a verifier device and a prover device.

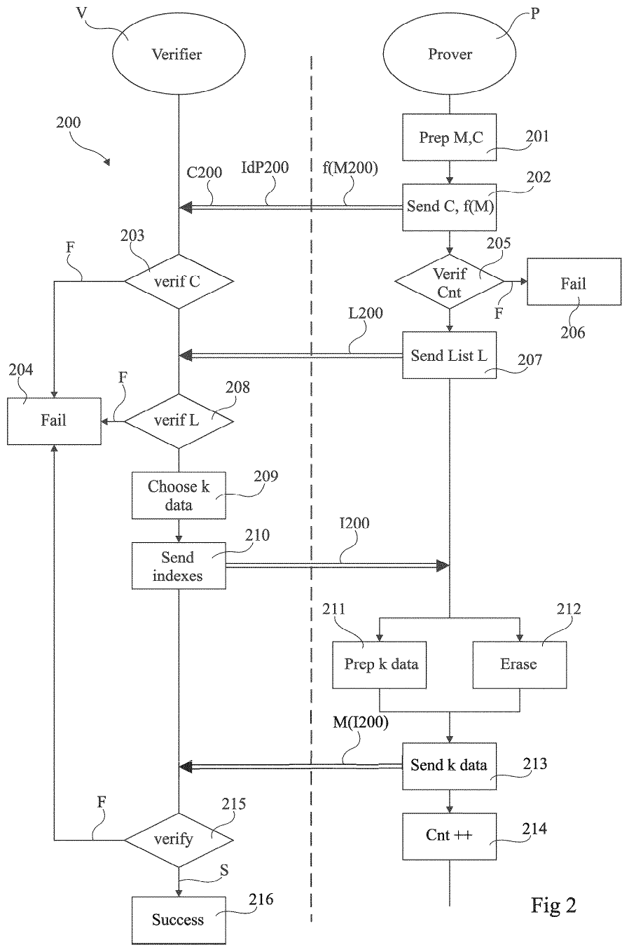

The embodiments described hereafter more particularly concern the implementation of an authentication method in which the verifier device selects a piece of data from a group of data transmitted by the prover device to implement the verification. The key feature of these embodiments is that the prover device stores far more data than data which are actually used and potentially disclosed during the implementation of an authentication method. Instead of storing data which are all used, each piece of data is comprised in a group of data, referred to hereafter as data tuples, of which only part of the data is used for the implementation of an authentication. Once one or a plurality of data of a tuple are used by the implementation of an authentication, the other data in the tuple which are not used are erased. Such an authentication method is described in detail in relation with FIGS. 2 to 4. A method of this type is particularly effective against malicious attacks in which a spy device, also called clone, attempts to take the place of a prover device. Indeed, due to the embodiments described hereafter, it is impossible for a spy device to have access to or learn all the secret data, or secrets, stored by a prover device by observing the authentications that it has implemented.

Further, the embodiments described hereafter are particularly adapted to the authentication of electronic devices of “consumable” type to a so-called “terminal” electronic device. Such devices are, for example, ink cartridges (consumable) configured to operate on a certain type of printer (terminal), or, for example, a card configured to operate with a payment terminal.

Further, the embodiments described hereabove are particularly adapted to being used in any type of industrial markets where the implementation of an authentication is required. More particularly, such an authentication method may be intended for: the automotive industry, for example in the field of automotive electrification or in the field of advanced driver assistance systems (ADAS); the industrial sector, for example in the field of green energy, in the field of infrastructure electrification, of the Internet of Things (IoT) and of smart homes, where electricity and energy consumption and data exchange are key elements; the personal electronics industry, for example in the field of mobile telephony and of the Internet of Things (IoT), as well as in high-speed interfaces; and the industry of communications equipment, computers, and peripherals, for example, in the field of infrastructure and data centers, and in the field of low earth orbit (LEO) satellites.

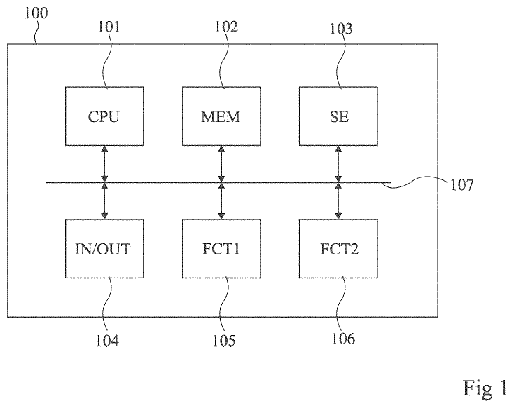

FIG. 1 is a block diagram very schematically showing an architecture of an example of an electronic device 100 configured to implement an authentication method. Device 100 may indifferently be a verifier device or a prover device of said authentication method. The authentication methods are described in relation with FIGS. 2 to 4.

According to an example, electronic device 100 comprises a processor 101 (CPU) configured to implement different processing operations on data stored in memories and/or supplied by other circuits of device 100. According to an embodiment, processor 101 is configured to implement an authentication method.

According to an example, electronic device 100 further comprises one or a plurality of memories 102 (MEM) of different types, including, for example, a non-volatile memory, a volatile memory, and/or a read-only memory. Each memory 102 is configured to store different types of data. According to an embodiment, memory or memories 102 are configured to store, preferably securely, data enabling the implementation of an authentication method.

According to an example, electronic device 100 further comprises a secure element 103 (SE) configured to process sensitive and/or secret data. Secure element 103 may comprise its own processor(s), its own memory or memories, etc. According to an embodiment, secure element 101 may be configured to implement an authentication method, or, at least, to storing data allowing the implementation of an authentication method.

According to an example, electronic device 100 may further comprise one or a plurality of interface circuits 104 (IN/OUT) configured to send and/or receive data originating from outside device 100. Interface circuits 104 may further be configured to implement a data display, for example, a display screen. According to an embodiment, interface circuit(s) 104 are configured to implement an authentication method, or, at least, to storing data enabling the implementation of an authentication method.

According to an example, electronic device 100 further comprises different functional operation circuits 105 (FCT1) and 106 (FCT2) configured to perform different functions. As an example, circuits 105 and 106 may comprise measurement circuits, data conversion circuits, etc. According to an embodiment, circuits 105 and 106 may comprise one or a plurality of circuits configured to implement an authentication method, or, at least, to storing data enabling the implementation of an authentication method.

According to an example, electronic device 100 further comprises one or a plurality of data buses 107 configured to transfer data between its various components.

According to an embodiment, a system comprising two devices of the type of device 100 may be configured to implement an authentication method. Such a system is called an authentication system.

More generally, electronic device 100 may be a computer which comprises means or program code instructions for the execution of the steps of an authentication method according to an embodiment. According to a first example, electronic device 100 may be a computer which comprises means or program code instructions for the execution of the steps of an authentication method according to an embodiment as a prover device. According to a second example, electronic device 100 may be a computer which comprises means or program code instructions for the execution of the steps of an authentication method according to an embodiment as a verifier device. According to a third example, electronic device 100 may be a computer which comprises means or program code instructions for the execution of the steps of an authentication method according to an embodiment as a prover device and as a verifier device.

FIG. 2 is a block diagram illustrating a first implementation mode of an authentication method 200 enabling to authenticate a first electronic device P, also called prover device P (Prover), to a second electronic device V, also called verifier device V (Verifier). In other words, authentication method 200 is adapted to being implemented by an authentication system comprising devices P and V. According to an embodiment, each of the devices P and V is of the type of the device 100 described in relation with FIG. 1.

As previously described, authentication method 200 is a method of verifier/prover type.

An initial step 201 (Prep M, C), implemented by device P, is a step of preparing data used for the successive steps of method 200. This step may be implemented once, and then may be used for a plurality of implementations of authentication method 200.

According to an embodiment, during this initial step 201, prover device P generates data enabling it to implement authentication method 200. More particularly, device P generates a list M200 of s data groups, also called data tuples, where s is an integer greater than or equal to one. Each group in list M200 comprises t data, t being an integer greater than one. As an example, the data comprised in list M200 are binary data.

For the rest of the description, list M200 can be represented as a matrix comprising s rows and t columns, in which: each coefficient m200ᵢⱼ of the matrix, i being an integer in the range from 0 to s−1 and j being an integer in the range from 0 to t−1, represents a piece of data; and each row of the matrix represents a group of t pieces of data as defined hereabove.

Thus, list M200 can be represented by the following mathematical formula:

$$M = {( m {200}_{ij} )}_{0 \leq i \leq s - 1 , 0 \leq j \leq t - 1}$$

Prover device P is further configured to implement a function f that device V is also capable of implementing. According to an embodiment, function f is a one-way function, that is, a non-invertible function or a quasi-one-way or quasi-invertible function, that is, a function for which an inversion operation requires significant computational resources. According to an example, function f may be a modular exponentiation function, a scalar multiplication function on an elliptic curve, a hash function. Other examples of functions f are available to those skilled in the art.

Further, during this initial step 201, prover device P may generate an image f(M200) of the data in list M200 by operation of function f. For this purpose, function f is applied to each piece of data of the data groups of list M200. Thus, the image f(M200) of list M200 can be represented in matrix form by the following mathematical formula:

$$f ( M ) = {( f ( m {200}_{ij} ) )}_{0 \leq i \leq s - 1 , 0 \leq j \leq t - 1}$$

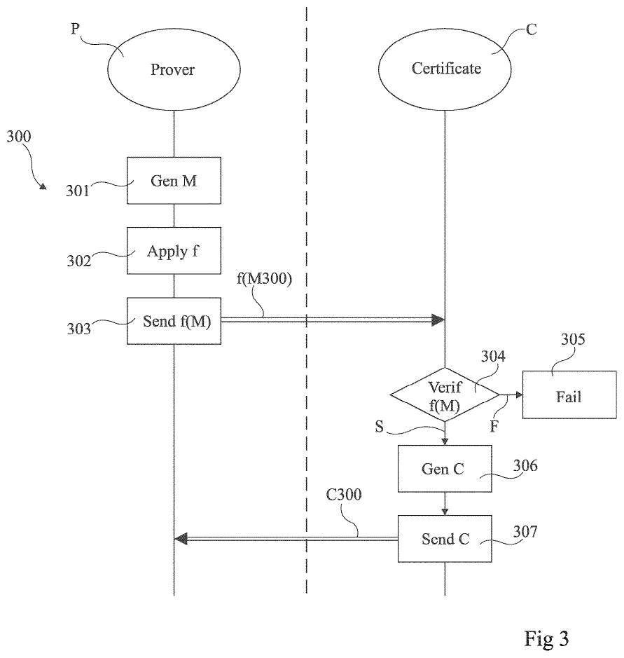

Further, during this initial step 201, prover device P may, for example, have itself certified by a certifier device, that is, prover device P may ask a certifier device to generate a certificate for it. This certification operation aims at obtaining a proof of trust from a device considered reliable, called certifier device hereafter. At the end of a certification operation, device P obtains a certification piece of data C200, or certificate C200. According to an example, the certification piece of data is dependent on an identification piece of data IdP200, or IdP200 identifier, of prover device P. According to an example, the certification piece of data is further dependent on the data of list f(M200). According to an example, the certification piece of data is further dependent on function f. An example of a certification step is described in detail in relation with FIG. 3.

At a step 202 (Send C), successive to step 201, carried out by device P, authentication method 200 begins with the sending of data by prover device P to verifier device V. According to an example, device P sends its identifier IdP200, its certificate C200, and the image f(M200) of list M200 generated by application of function f.

At a step 203 (Verif C, f(M)), successive to step 202, implemented by device V, device V receives the data sent at step 202, that is, for example, identifier IdP200, certificate C200, and image f(M200), and performs a verification of these data. According to an embodiment, at step 203, device V implements a step of verification of certificate C200. According to an example, at step 203, device V carries out a step of verification of identifier IdP200. According to an example, at step 203, device V implements a step of verification of image f(M200). If the implemented verification(s) indicate(s) that one of the received data is not compliant with one or a plurality of criteria (output F of step 203), then the next step is a step 204 (Fail), otherwise the authentication method continues.

At step 204, carried out by device V, device V has determined that a verification step had provided a negative result. This indicates that at least one of the pieces of data supplied by device P is non-compliant and that the authentication of device P is not possible with device V. The authentication method thus stops and ends in a failure of the authentication of device P to device V.

At a step 205 (Verif Cnt), successive to step 202, implemented by device P, device P verifies the value Cnt200 of an internal counter. This internal counter enables to track the number of times that device P implements authentication method 200. Thus, each time device P successfully implements authentication method 200, it increments the value Cnt200 of the internal counter.

According to an alternative embodiment, the internal counter could enable to track the number of times that device P implements authentication method 200 successfully or unsuccessfully. Thus, each time device P implements authentication method 200 and reveals one or a plurality of secrets, the counter can be incremented.

Thus, at step 205, device P verifies that value Cnt200 does not exceed a maximum value Cnt200Max. If value Cnt200 is equal to or greater than maximum value Cnt200Max (output F of step 205), then the next step is a step 206 (Fail), otherwise the authentication method continues. Maximum value Cnt200Max is defined with respect to the number of data groups in list M200. According to an embodiment, maximum value Cnt200Max is smaller than or equal to integer s.

According to an alternative embodiment, step 205 may be carried out at other times of authentication method 200, such as, for example, before the execution of step 202, after the execution of a step 207 described hereafter, or before the execution of a step 213 described hereafter.

At step 206, carried out by device P, successive to step 205, device P has determined that it had carried out the authentication method too many times. The authentication of device Pis not possible with device V. The authentication method thus stops, and ends in a failure of the authentication of device P to device V.

At a step 207 (Send List L), successive to step 205, implemented by device P, prover device P sends to verifier device V a list L200 enabling to identify data groups of list M200 which have already been previously used to implement authentication method 200. According to an example, when device P implements its first authentication method 200, list L200 is an empty list.

According to an embodiment, list L200 comprises indexes of data groups of list M200 which have already been used. The index of a data group is the number of the row corresponding to the group in the matrix representing list M200. In other words, the index of a data group is given by the value of the integer i, defined above, associated therewith.

According to another embodiment, list L200 comprises indexes of data groups already used, but also comprises values of the data of these data groups already used to implement authentication method 200. In this case, it can be said that list L200 comprises pairs, each comprising the index of an already-used data group and the value(s) of the already-used data of said data group.

Further, optionally, at step 207, prover device P may also send to verifier device V the value Cnt200 of its internal counter.

At a step 208 (Verif L), successive to step 207, implemented by device V, verifier device V has received list L200 and implements one or a plurality of operations of verification of this list L200.

According to a first example, verifier device V verifies whether the number of indexes of list L200 does not exceed the number of data groups in the previously-supplied image f(M200). According to a variant, if the verifier device has also received value Cnt200 from the internal counter of prover device P, verifier device V verifies that the number of indexes in list L200 is compatible with value Cnt200. More particularly, if each implementation of authentication method 200 uses k data comprised in a group, k being an integer in the range from 1 to integer s−1, then the number of elements of list L200, noted #(L200), follows the following mathematical inequality:

$$\# ( L 200 ) \leq Cnt 200 * k \leq ( Cnt 200 Max - 1 ) * k$$

According to a second example, if list L200 comprises the data values of the already-used groups, verifier device V verifies whether these data values are correct. For this purpose, verifier device V may implement function f and apply it to the received data.

According to a third example, if list L200 comprises the values of the data of the already-used groups, verifier device V verifies whether these data values belong to different data groups.

Those skilled in the art will be able to find other ways of verifying list L200.

If the verification(s) carried out indicate(s) that the received list L200 does not comply with one or a plurality of criteria (output F of step 208), then the next step is step 204, otherwise the authentication method continues.

In a step 209 (Choose k data), successive to step 208, implemented by device V, verifier device V selects k data from the image f(M200) of the list M200 supplied by prover device P at step 202, k being an integer in the range from 1 to integer s−1. In other words, verifier device V generates a list I200 of k data indexes. There is here called index of a piece of data the number of the row and the number of the column corresponding to the piece of data in the matrix representing list M200 or image f(M200). In other words, the index of a data group is given by the values of the integers i and j, defined above, associated therewith. The data selected by the verifier cannot belong to data groups already used by the prover in previous authentication methods. In other words, the row numbers of the selected data cannot correspond to row numbers present in list L200.

According to another embodiment, list I200 does not comprise the data indexes, but only comprises the values of the images, by function f, of data. Generally, list I200 can be said to comprise part of information relative to the data to be used.

At a step 210 (Send indexes), successive to step 209, implemented by device V, verifier device V sends list I200 to prover device P.

At a step 211 (Prep k data), successive to step 210, implemented by device P, prover device P receives list I200 and prepares the k data of list M200 corresponding to the indexes of list I200. In other words, prover device P selects the data group(s) chosen by verifier device V, and chooses from this or these group(s) the data selected by verifier device V. It will be said hereafter that at step 211, prover device P prepares a list M(I200) of data of list M200 corresponding to the indexes of list I200.

According to a variant, at step 211, device P may verify the list I200 that it has received, and stop the method if the latter does not comply.

At step 212 (Erase), successive to step 210, implemented by device P simultaneously to step 211, prover device P erases the data of the group(s), or tuples, selected by verifier device V, which have not been selected by verifier device V. In other words, prover device P erases from list M200 all the data of the selected group(s), the indexes of which are not in list I200.

According to an alternative embodiment, at step 212, prover device P erases from list M200 all the data of the group(s) selected by verifier device V. In practice, the data which are to be sent to verifier device V are only erased after their sending.

At a step 213 (Send k data), successive to step 212, implemented by device P, prover device P sends to verifier device V the requested list M(I200) of data.

At a step 214 (Cnt ++), successive to step 213, carried out by device P, prover device P increments the value Cnt200 of its internal counter. According to a variant, step 214 may be carried out simultaneously to step 211 or to step 213.

At a step 215 (Verify), successive to step 213, implemented by device V, verifier device V receives the list M(I200) of the k requested data and verifies their compliance. For this purpose, verifier device V uses function f and applies it to each of the pieces of data in list M(I200). Then, verifier device V compares the images by function f of the pieces of data of list M(I200) with the pieces of data of image f(M200) selected due to the indexes of list I200.

If the verification(s) carried out indicate that one of the received piece of data does not comply (output F of step 215), then the next step is step 204, otherwise the next step is step 216 (Success).

At step 216, carried out by device V, verifier device V has effectively verified all the data supplied by prover device P, all these data are correct. Prover device P is then authenticated to verifier device V, and the authentication method is a success. According to an example, step 214 is carried out by prover device P after step 216.

An advantage of this method is that deleting part of the unused data in list M200 enables to prevent a malicious electronic device from taking the place of prover device P. Indeed, a malicious device that does not have data list M200 will not be able to reconstruct it entirely based on the data potentially disclosed at the successive steps 213 of implementation of authentication method 200, since part of the data of a data group is erased without ever being communicated.

FIG. 3 is a block diagram illustrating an example of implementation of a method 300 of certification of an electronic device, such as the prover device P (Prover) of FIG. 2, to an electronic device C (Certificate), also called certifier device C. In other words, method 300 is adapted to being used during step 201 described in relation with FIG. 2.

At an initial step 301 (Gen M), carried out by device P, prover device P generates a list M300 of data groups of the type of the list M200 described in relation with FIG. 2. In other words, device P generates a list M300 of s data groups. Each group in list M300 comprises t data. Integers s and t being identical to those defined in relation with FIG. 2.

At a step 302 (Apply f), successive to step 301, implemented by device P, device P uses the function f defined in relation with FIG. 2 and applies it to list M300 to obtain an image f(M300). Image f(M300) is of the type of the image f(M200) described in relation with FIG. 2. In other words, function f is applied to each piece of data of the data groups of list M300.

At a step 303 (Send f(M)), successive to step 302, carried out by device P, prover device P sends image f(M300) to certifier device C. According to an example, prover device P further sends an identification piece of data IdP300, or identifier IdP300, to certifier device C.

At a step 304 (Verif f(M)), successive to step 303, implemented by device C, certifier device C has received image f(M300), and, if present, identifier IdP300, and initiates one or a plurality of operations of verification of these data.

According to a first example, certifier device C may verify that function f has been correctly applied, for example by analyzing the format of the data supplied by prover device P.

According to another example, certifier device C verifies whether identifier IdP300 is not part of a list of identifiers for which it is forbidden to provide a certification piece of data.

If the verifications(s) carried out indicate(s) that one of the received pieces of data does not comply with one or a plurality of criteria (output F of step 304), then the next step is step 305 (Fail), otherwise the certification operation continues.

At step 305, certifier device C has determined that a verification step had provided a negative result. This indicates that at least one of the pieces of data supplied by device P is non-compliant and that the certification of device P is not possible. Certification method 300 thus stops, and ends in a failure in the certification of device P.

At a step 306 (Verif f(M)), successive to step 304, carried out by device C, the data of image f(M300) have been recognized as compliant by certifier device C. Certifier device C thus prepares a certification piece of data C300. For this purpose, according to an example, certifier device C uses the data of image f(M300) and, if present, identifier IdP300. According to an example, certifier device C obtains certificate C by applying to the data of image f(M300) and, if present, to identifier IdP300, a signature function.

At a step 307 (Verif f(M)), successive to step 306, carried out by device C, the certifier device sends to prover device P certificate C300. Prover device P is now certified.

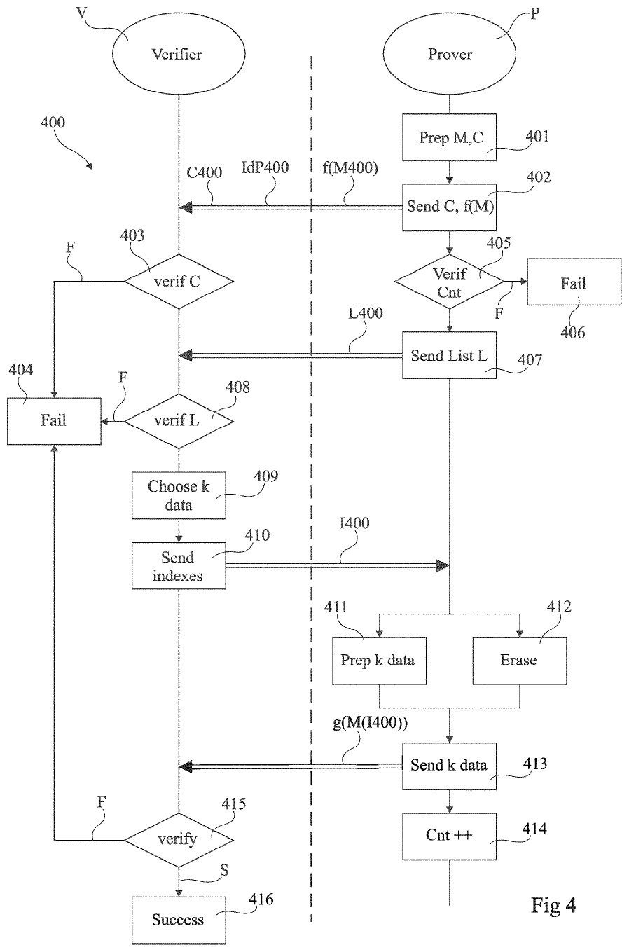

FIG. 4 is a block diagram illustrating a second implementation mode of an authentication method 400 enabling to authenticate a first electronic device P, called prover device P (Prover), to a second electronic device V (Verifier), called verifier device V (Verifier). In other words, authentication method 400 is adapted to being implemented by an authentication system comprising devices P and V. According to an embodiment, devices P and V are of the type of the device 100 described in relation with FIG. 1.

Authentication method 400 is a method of verifier/prover type.

Authentication method 400 is similar to the authentication method 200 described in relation with FIG. 2. The elements common to methods 200 and 400 are not described again in detail. Only the differences between methods 200 and 400 are highlighted.

More particularly, method 400 is a specific application of method 200 for which the data generated by prover device P in the form of a list M400 are secret data, and for which a second function g is used to prove to verifier device V knowledge of the requested data of list M400.

An initial step 401 (Prep M, C), implemented by device P, is a step of preparing data used for the successive steps of method 400. This step may be implemented once and then used for a plurality of implementations of authentication method 400.

According to an embodiment, during this initial step 401, prover device P generates data enabling it to implement authentication method 400. More particularly, device P generates a list M400 of s data groups, also called data tuples, s being an integer greater than or equal to one. Each group of list M400 comprises t data, t being an integer greater than one. As an example, the data comprised in list M400 are binary data.

Like the list M200 described in relation with FIG. 2, list M400 can be represented as a matrix given by the following mathematical formula:

$$M = {( m {400}_{ij} )}_{0 \leq i \leq s - 1 , 0 \leq j \leq t - 1}$$

According to an embodiment, the data in list M400 are secret data, the values of which must not be revealed. According to an example, the data of list M400 are signature keys.

Prover device P is further configured to implement function f. Function f has already been described in relation with FIG. 2. According to a specific example, function f may be a function enabling to obtain a public signature key from a private signature key.

Prover device P is further configured to implement a function g. According to an example, function g is a signature function enabling to provide a signature based on a private key. According to a specific example, function g is a signature function based, for example, on modular exponentiation or scalar multiplication on an elliptic curve. Other examples of functions g are available to those skilled in the art. According to another embodiment, function g is the identity function, in which case method 400 is identical to method 200.

Further, during this initial step 401, prover device P may generate an image f(M400) of the data in list M400 by function f. According to an example, image f(M400) represents public keys associated with the private keys in list M400. For this purpose, function f is applied to each piece of data in the data groups of list M400. Thus, the image f(M400) of list M400 can be represented by the following mathematical formula:

$$f ( M ) = {( f ( m {400}_{ij} ) )}_{0 \leq i \leq s - 1 , 0 \leq j \leq t - 1}$$

Further, during this initial step 401, prover device P may, for example, be certified by a certifier device, for example by a certification method of the type of that described in relation with FIG. 3. At the end of a certification operation, device P obtains a certification piece of data C400, or certificate C400.

At a step 402 (Send C), successive to step 401, carried out by device P, authentication method 400 begins with the sending of data by prover device P to verifier device V. According to an example, device P sends its identifier IdP400, its certificate C400, and the image f(M400) of list M400 by function f.

At a step 403 (Verif C, f(M)), successive to step 402, carried out by device V, device V receives the data sent at step 402, that is, identifier IdP400, certificate C400, and image f(M400), and performs a verification of these data. The verification operation(s) carried out at step 403 are of the type of the verification operation(s) carried out at step 203 of method 200. If the performed verification(s) indicate that one of the received pieces of data is not compliant (output F of step 403), then the next step is a step 404 (Fail), otherwise the authentication method continues.

At step 404, implemented by device V, device V has determined that a verification step has provided a negative result. This indicates that at least one of the pieces of data supplied by device P is non-compliant and that the authentication of device P is not possible with device V. The authentication method thus stops and ends in a failure of the authentication of device P to device V.

At a step 405 (Verif Cnt), successive to step 402, implemented by device P, device P verifies the value Cnt400 of an internal counter. This internal counter enables to track the number of times that device P implements authentication method 400. Thus, each time device P successfully implements authentication method 400, it increments the value Cnt400 of the internal counter.

According to an alternative embodiment, the internal counter could enable to track the number of times that device P implements authentication method 200 successfully or unsuccessfully. Thus, each time device P implements authentication method 400 and uses one or a plurality of secrets, the counter can be incremented.

Thus, at step 405, device P verifies that value Cnt400 does not exceed a maximum value Cnt400Max. If value Cnt400 is equal to or greater than maximum value Cnt400Max (output F of step 405), then the next step is a step 406 (Fail), otherwise the authentication method continues.

According to an alternative embodiment, step 405 may be implemented at other times of authentication method 400, such as, for example, before the execution of step 402, after the execution of a step 407 described hereafter, or before the execution of a step 413 described hereafter.

At step 406, carried out by device P, device P has determined that it had carried out the authentication method too many times. The authentication of device P is not possible with device V. The authentication method thus stops, and ends in the failure of the authentication of device P to device V.

At a step 407 (Send List L), successive to step 405, carried out by device P, prover device P sends to verifier device V a list L400 enabling to identify data groups of list M400 which have already been previously used to implement authentication method 400.

According to an embodiment, like the list L200 of method 200, list L400 comprises indexes of already-used data groups of list M400, but may also comprise values of data of these groups already used to implement authentication method 400. In this case, it can be said that list L400 can be said to comprise pairs, each comprising the index of an already-used data group and the data value(s) of said data group already used. According to an example, the data values of said group may be signatures generated from private keys.

At a step 408 (Verif L), successive to step 407, implemented by device V, verifier device V has received list L400 and implements one or a plurality of operations of verification of this list L400. Step 408 is similar to the step 208 of method 200, and implements similar verification operations. Those skilled in the art will be able to find other ways of verifying list L400.

If the performed verification(s) indicate that the received list L400 is not compliant with one or a plurality of criteria (output F of step 408), then the next step is step 404, otherwise the authentication method continues.

At a step 409 (Choose k data), successive to step 408, implemented by device V, verifier device V chooses k data from the image f(M400) in the list M400 supplied by prover device P at step 402, k being an integer in the range from 0 to integer s. In other words, verifier V generates a list I400 of k data indexes.

At a step 410 (Send indexes), successive to step 409, implemented by device V, the verifier device sends list I400 to prover device P.

At a step 411 (Prep k data), successive to step 410, carried out by device P, prover device P receives list I400 and prepares the k data of list M400 corresponding to the indexes of list I400. In other words, prover device P selects the data group(s) chosen by verifier device V, and chooses from this group(s) the data selected by verifier device V. It can then be said that at step 411, prover device P prepares a list M(I400) of data of list M400 corresponding to the indexes of list I400.

Further, and conversely to authentication method 200, prover device P applies function g to list M(I400) to obtain an image g (M(I400)). For this purpose, function g is applied to each piece of data of list M(I400). Function g here has the function of preventing the disclosure of the data of list M400 during their sending to verifier device V. Further, according to an example, function g is a function of generation of a signature with a private key, and the message to be signed is fixed and predetermined in advance. According to another example, the message to be signed is chosen by device V.

At a step 412 (Erase), successive to step 410 and implemented by device P simultaneously to step 411, prover device P erases the data of the group selected by verifier device V which have not been selected by verifier device V. In other words, prover device P erases from list M400 all the data of the selected group, the indexes of which are not in list I400.

According to an alternative embodiment, at step 412, prover device P erases from list M400 all the data of the group selected by verifier device V.

At a step 413 (Send k data), successive to step 412, implemented by device P, prover device P sends to verifier device V the requested list g (M(I400)) of data.

At a step 414 (Cnt ++), successive to step 413, implemented by device P, prover device P increments the value Cnt400 of its internal counter.

At a step 415 (Verify), successive to step 413, implemented by device V, verifier device V receives the list g (M(I400)) of the k requested data and verifies their compliance. For this purpose, verifier device V may use a verification function, different from function f and list f(I400) which corresponds, according to an example, to a list of public keys. According to an example, the verifier verifies that the signatures of list g (M(I400)) are correct, based on the public signature keys of list f(I400).

If the verification(s) carried out indicate that one of the received pieces of data is not compliant (output F of step 415), then the next step is step 404, otherwise the next step is step 416 (Success).

At step 416, carried out by device V, verifier device V has verified all the data supplied by prover device P, all these data are correct. Prover device P is then authenticated with verifier device V, and the authentication method is a success. According to an example, step 414 is carried out by prover device P after step 416.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. A method of authenticating a first device to a second device, the first device storing a first list of data groups, comprising the following steps:
a) sending, by the second device to the first device, a second list of information relative to data;
b) sending, by the first device to the second device, a third list of images, by a first function, of data of said first list of data groups, having as information that of said second list of information relative to data; and
c) verifying, by the second device, whether the images of the data of said third list of images comply with the data of a fourth list of data groups corresponding to the image of the first list of data groups by a second function having its information comprised in the second list of information relative to data.

2. The method according to claim 1, further comprising, before step a), step d) sending, by the first device to the second device, said fourth list of data groups.

3. The method according to claim 2, further comprises, between step d) and step a), step f) sending, by said first device to the second device, a fifth list of information relative to data groups of said fourth list of data groups which have already been used to implement an authentication method, and
wherein, at step a), the second list of information relative to data comprises no information already comprised in said fifth list of information.

4. The method according to claim 3, wherein the fifth list comprises pairs comprising a data index and the value of said data associated with said data index.

5. The method according to claim 3, further comprising, after step f), step g) verifying, by the second device, said fifth list of information.

6. The method according to claim 2, wherein step d) further comprises sending, by the first device, a certificate, and further comprising, after step d), step h) verifying, by said second device, said certificate.

7. The method according to claim 1, further comprising, between step b) and step c), step e) erasing, by the first device, from said first list of data groups the entire data groups of the data having their information forming part of said third list of images.

8. The method according to claim 1, wherein said second list of information relative to data is a list of data indexes.

9. The method according to claim 1, wherein said second list of information relative to data is a list of data values.

10. The method according to claim 1, further comprising counting, using a counter of said first device, a number of times that the first device implements said authentication method.

11. The method according to claim 10, further comprising, when said counter exceeds a maximum value, stopping by said first device the implementation of the authentication method so that the first device is not authenticated to the second device.

12. The method according to claim 10, further comprising verifying, by said second device, the value of said counter.

13. The method according to claim 1, wherein the first device is authenticated to the second device when step c) verification is a success, and wherein the first device is not authenticated to the second device when step c) verification is not a success.

14. The method according to claim 1, wherein said second list of information relative to data sent in step a) does not include information which has been used in any previous implementations of the authentication method between the first and second devices.

15. The method according to claim 14, further comprising sending, by the first device to the second device, a fifth list of data comprising information relating to groups of data of said fourth list of datasets which were used in said previous implementations of the authentication method, said second list of information relative to data not including information in said fifth list of data.

16. An electronic device configured to operate as the first device in the method of authenticating of claim 1.

17. An electronic device configured to operate as the second device in the method of authenticating of claim 1.

18. An authentication system, comprising a first device and a second device configured to implement the method of claim 1.

19. A computer program product comprising program code instructions for the execution of the steps of the method according to claim 1 as one of the first device or the second device, when said program is executed on a computer.
